(19) United States
(12) Patent Application Publication
(10) Pub. No.: US 2004/0252129 A1
(43) Pub. Date: Dec. 16, 2004

(54) Methods and apparatus for a variable depth display

(76) Inventor: Kim Pallister, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/460,015

(22) Filed: Jun. 11, 2003

(51) Int. Cl. G09G 5/02

(52) U.S. Cl. 345/601

(57) ABSTRACT

An apparatus and method of creating a variable depth display, comprising a display converter that reads data from a primary buffer corresponding to a pixel location, wherein the display converter reads data from either a marker buffer or a lookup table corresponding to the pixel location wherein a marker buffer value or lookup table value is obtained. The display converter then reads data from at least one secondary buffer corresponding to the pixel location if the marker buffer value or the lookup table value is a high resolution value, and calculates an output color for the pixel location. The display converter thus contains varying levels of color depth for each pixel read depending on whether the secondary buffers are utilized to calculate the color output for the pixel location.

### FIELD OF THE INVENTION

The present invention relates generally to graphic display systems and, more specifically, to generating variable depth graphics displays

### BACKGROUND OF THE INVENTION

Display systems for personal computers, workstations, and other computer systems incorporating a computing device, such as a central processing unit (CPU), are used to show characters, graphics, pictorial images and other visually perceived information. Display systems may include a display screen, such as a cathode ray tube (CRT), a liquid crystal display (LCD), or a plasma display. The display screen is divided into display units, or picture elements, which are known to those skilled in the art as “pixels.” Pixel values for intensity and/or color are stored in memory in digital form, and converted to the appropriate display signal for the display by a display converter. The display converter is in turn controlled by the CPU of the computer system, or in some cases by a co-processor aiding the CPU. Display converters, for example a RAMDAC (random access memory digital to analog converter) converter, may access or read the digital representations of the information (bits) to be displayed on the display screen by accessing a pixel bitmap, which is a location in computer memory which organizes the pixel data (pixel bits) such that each pixel is represented by one or more bits. The area of memory which stores the bitmap for a display currently being shown is called a frame buffer. The display converter is then tasked with reading the frame buffer and translating it into a format that is compatible with the display screen itself. For example, this could be done through the use of a digital-to-analog converter (DAC), which converts the pixel data to an appropriate voltage level to drive an electron gun in a cathode ray tube based display system.

In general, the number of bits per pixel is referred to as the pixel, or color depth. For example, an 8-bit color display requires 8 bits to describe each pixel, allowing for 256 different levels of color (which could be 256 levels of gray from black to white, or could be 256 colors of different hues and intensities). In some cases, the 8-bit entries are indices into a look-up table, or palette, of other color values. This is referred to as a palletized display.

Different display purposes require different levels of display color depth. High quality display of photographic images may require 24 bits per pixel, while the display of black-on-white text documents may require only 4 or 8 bits per pixel. Higher degrees of color depth are used in cases where the image may be used in subsequent calculations, and where the degree of precision may result in an output from these calculations where the error is amplified to a degree where it is visible. There are instances in which more than 24 bits are used to describe each pixel, for example48-bit color depths may be used. It is likely that some application programs running on the computer system may have a need for a higher degree of color depth than others, and that these applications may run at the same time, and display their user interfaces in different regions of the display screen.

Accordingly, there is a need for a mechanism that provides a variable pixel depth on the display screen. Such a mechanism allows, for example, a high fidelity image in a part of a document, displayed at 24 bit color, while the rest of the document requires only 8 bits per pixel to display, since that is sufficient for plain text. The method and apparatus of the present invention provides such a mechanism.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 is a diagram illustrating an example of a computer system according to an embodiment of the present invention.

FIG. 2 is a flowchart of a method according to an embodiment of the present invention.

FIG. 3 is a diagram illustrating an example of a computer system according to another embodiment of the present invention.

FIG. 4 is a flowchart of a method according to another embodiment of the present invention.

FIG. 5 is a diagram illustrating a sample system capable of being operated with a method for creating a variable depth display in accordance with the present invention.

### DETAILED DESCRIPTION OF THE PRESENT INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

A method and apparatus for generating a variable depth display is described. The method and apparatus comprise a display converter that reads data from a primary buffer corresponding to a pixel location, wherein the display converter reads data from either a marker buffer corresponding to the pixel location wherein a marker buffer value is obtained; or uses a lookup table to convert the pixel value from the primary buffer into either a color or a high resolution value via a lookup table value. If the marker buffer value or the lookup table value indicates a high resolution value is located at the pixel location, the display converter then reads data from at least one secondary buffer corresponding to the pixel location. The display converter then calculates an output color for the pixel location. The display converter thus contains varying levels of color depth for each pixel read depending on whether the secondary buffers are utilized to calculate the color output for the pixel location.

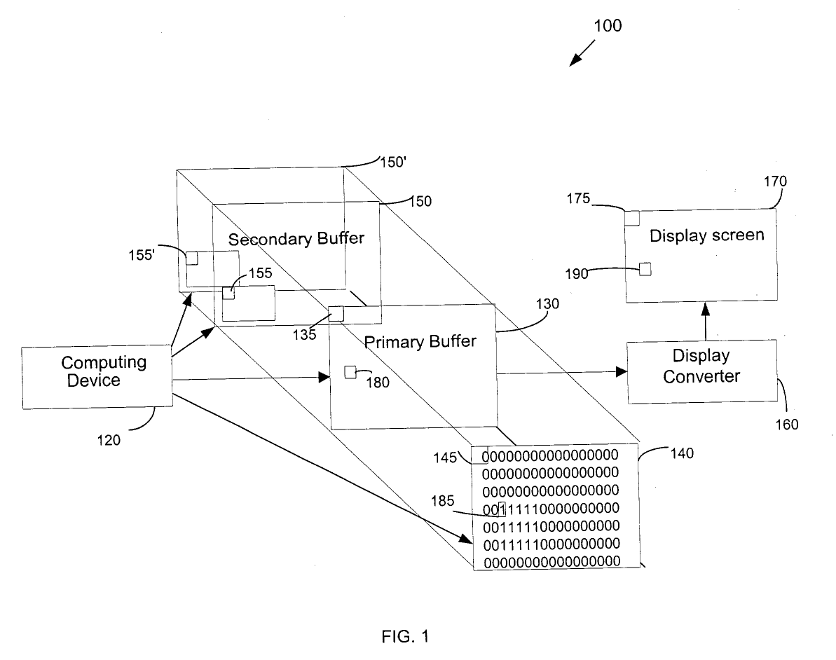

FIG. 1 is a diagram of a computer system 100 according to an embodiment of the present invention. The computer system 100 includes a computing device 120, such as a CPU (central processing unit), a primary buffer 130 (such as a frame buffer), a marker buffer 140, at least one secondary buffer (depicted in FIG. 1 as a first secondary buffer 150 and a second secondary buffer 150′), a display converter 160 (such as a random access digital to analog converter, (RAMDAC) display converter) and a display screen 170 (for example, a cathode ray tube (CRT) screen). The computing device 120 may generate output data, such as pixel data, to be received by the primary buffer 130. The primary buffer 130 is an area of memory that stores pixel data for a display currently being shown on the display screen 170. The pixel data may occupy a first primary buffer memory location 135 on the primary buffer 130, which corresponds to a first pixel location 175 on the display screen 170. The pixel data received by the first primary buffer memory location 135 from the computing device 120 may comprise low resolution pixel color depth information, and for example, by way of illustration and not limitation, may comprise 8 bits per pixel, or high resolution pixel color depth information, such as 24 bits per pixel.

The computing device 120 may also generate marker data to be received by the marker buffer 140. The marker buffer 140 is an area of memory that stores marker data such that a first marker buffer memory location 145 corresponds to the first primary buffer memory location 135 and the first pixel location 175 on the display screen 170. When the computing device 120 generates low resolution color depth information for the first pixel location 175, the first marker buffer value 145 may receive a low resolution value from the computing device 120, which may be designated as a “0” bit value, for example. When the computing device 120 generates low resolution color depth information, the first primary buffer memory location 135 may receive all of the display data generated (in this example 8 bits) by the computing device 120 for the first pixel location 175.

In the alternative, when the computing device 120 generates high resolution color depth information, such as 24 bits per pixel, in another area of the display screen 170, depicted in FIG. 1 as a second pixel location 190, a second primary buffer memory location 180 may receive 8 bits of display data, for example 8 bits of the red color component, and in addition, at least one secondary buffer memory location (located on the first secondary buffer 150 and the second secondary buffer 150′, and depicted as a first secondary memory location 155 and a second secondary memory location 155′, respectively) may each receive 8 bits of color information, for example the first secondary memory location 155 may receive 8 bits of the green color component, and the second secondary memory location 155′ may receive 8 bits of the blue color component. Thus, the 24 bits of color depth information generated by the computing device 120 for the second pixel location 190 in this example may be partitioned between the primary buffer 130 and at least one secondary buffer (such as the first secondary buffer 150 and/or the second secondary buffer 150′). When the computing device 120 generates high resolution color depth information for the second pixel location 190 in this example, the computing device 120 may generate an indicator of a high resolution value, such as a “1” bit value for a second marker buffer memory location 185 (corresponding to the second primary buffer location 180, and corresponding to both of the secondary buffer memory locations 150, 155′, in this example).

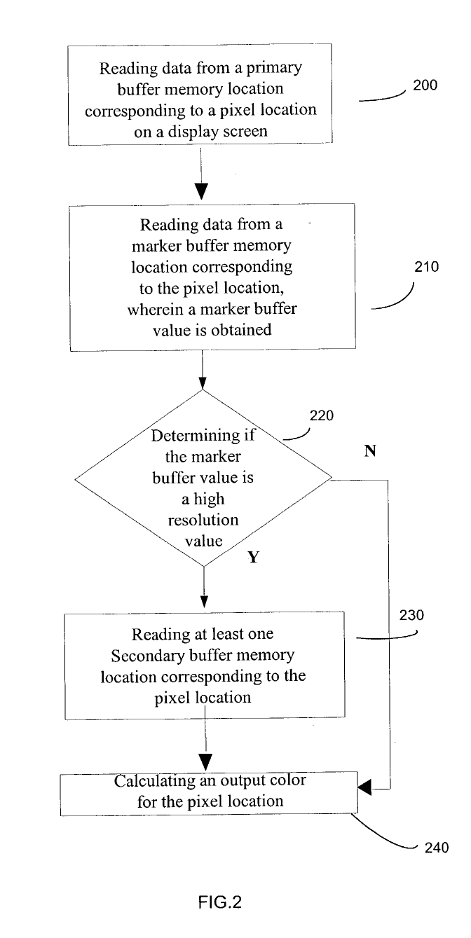

FIG. 2 depicts a flowchart of a method according to an embodiment of the present invention. The method may be used to create a variable depth display, in which a display converter, such as the display converter 160 depicted in FIG. 1, reads data from a primary buffer (such as the primary buffer 130 in FIG. 1), and may also read data from at least one secondary buffer (such as first secondary buffer 150 and/or the second secondary buffer 150′ in FIG. 1) if an indicator of a high resolution value is present on a marker buffer (such as marker buffer 140). The method includes reading data from a primary buffer memory location corresponding to a pixel location on a display screen 200, reading data from a marker buffer memory location corresponding to the pixel location, wherein a marker buffer value is obtained 210, determining if the marker buffer value is a high resolution value 220, if not, calculating an output color for the pixel location 240, otherwise, reading at least one secondary buffer memory location corresponding to the pixel location 230, and then calculating the output color for the pixel location 240. Calculating the output color for the pixel location 240 comprises utilizing the data from the primary buffer memory location and does not include utilizing the data from at least one secondary buffer memory location if the marker buffer value is a low resolution value, such as a “0” value (as depicted in FIG. 1 for the marker buffer memory location 145). If the marker buffer value indicates a high resolution value, calculating the output color comprises utilizing the data from the primary buffer memory location and the data from at least one secondary buffer memory location. After the display converter reads and calculates the output color for a particular pixel, the output color may be converted into a format compatible with a particular display screen technology, in a manner that is well known to those skilled in the art. Thus, the method of the present invention allows for different pixel color depths in different parts of the memory component of a computer display system. In addition, by primarily using memory allocated for low resolution applications, such as text applications, while only using additional memory allocated for high resolution applications when there is a high value marker present, memory is economized and cost of system operation is reduced.

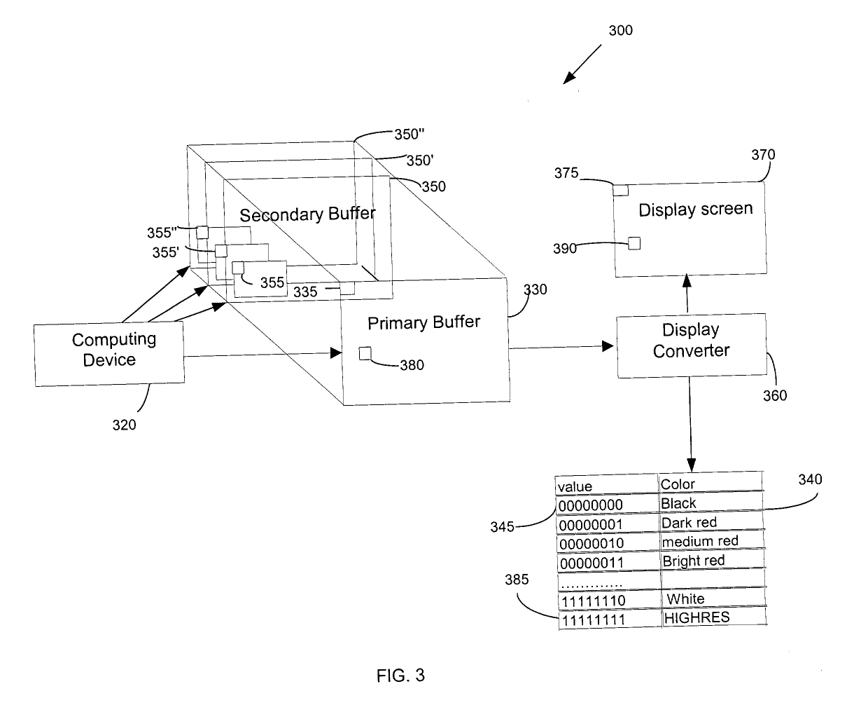

FIG. 3 depicts another embodiment of the present invention. The computer system 300 includes a computing device 320, a primary buffer 330, a lookup table 340, at least one secondary buffer (depicted in FIG. 3 as a first secondary buffer 350, a second secondary buffer 350′ and a third secondary buffer 350″), a display converter 360 and a display screen 370. The computing device 320 may generate output data, such as pixel data, to be received by the primary buffer 330. The primary buffer 330 is an area of memory that stores pixel data for a display currently being shown on the display screen 370. The primary buffer 330 may be a palettized buffer, in which the data received by the primary buffer 330 from the computing device 320 may be an index to a lookup table 340 (i.e. a palette) of available colors, for example, in the case of an 8 bit color display system the lookup table may allow for 256 different hues of color or shades of gray. The look up table 340 is well known in the art.

The pixel data received by the computing device 320 may occupy a first primary buffer memory location 335 on the primary buffer 330 which may correspond to a first pixel location 375 on the display screen 370. The pixel data received by the first primary buffer memory location 335 from the computing device 320 may comprise low resolution pixel color depth information, and for example, by way of illustration and not limitation, may comprise 8 bits per pixel, or high resolution pixel color depth information, such as 24 bits per pixel. When the computing device 320 generates low resolution pixel color depth information, the first primary buffer memory location 335 receives all of the pixel data generated by the computing device 320, which is then indexed to a corresponding color value in the lookup table 340 (depicted as the lookup table location 345 in FIG. 3.), which corresponds to the first primary buffer memory location 335 data value and is sent to the display screen 370 by the display converter 360 in a format suitable for display on the display screen 370.

When the computing device 320 generates high resolution pixel color depth information, for example for another location on the display screen 370, such as in a second pixel location 390, a second primary buffer memory location 380 corresponding to the second pixel location 390 may receive pixel data corresponding to a high resolution value (shown as the lookup location 385 in FIG. 3) located on the lookup table 340. For example, the second primary buffer memory location 380 may receive pixel data corresponding to a “11111111” value for an 8 bit lookup table as depicted in FIG. 3. The computing device 320 then sends the high resolution pixel color depth information for the second pixel location 390 to at least one secondary buffer memory location (shown in FIG. 3 as a first secondary buffer memory location 355, a second secondary buffer memory location 355′ and a third secondary buffer memory location 355″) located on at least one secondary buffer (e.g., secondary buffers 350, 350′, and/or 350″). For example, the first secondary buffer memory location 355 may receive 8 bits of a red color component, the second secondary buffer memory location 355′ may receive 8 bits of a green color component, and the third secondary memory location 355″ may receive 8 bits of a blue color component. Thus, the 24 bits of high resolution pixel color depth information generated by the computing device 320 for the second pixel location 390 in this example may be partitioned between at least one secondary buffer memory location (e.g., secondary buffer memory locations 355, 355′, and/or 355″).

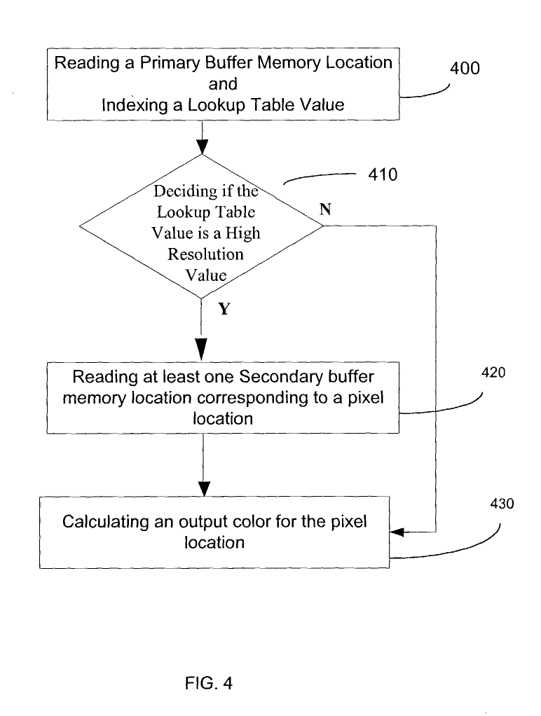

FIG. 4 depicts a flowchart of a method according to the embodiment of FIG. 3 of the present invention. The method may be used to create a variable depth display, in which a display converter, such as display converter 360, reads data from a primary buffer memory location, such as the primary buffer memory location 335, indexes a lookup value from a lookup table (such as lookup table 340) corresponding to the pixel data contained in the primary buffer memory location, and may also read data from at least one secondary buffer memory location (such as the secondary buffer memory locations 355, 355′, and/or 355″ in FIG. 3) if a high resolution value is indexed on the lookup table.

The method includes reading a primary buffer memory location and indexing a lookup table value 400, deciding if the lookup table value indicates a high resolution value 410, if not, calculating an output color for the pixel location 430, otherwise (if the lookup table value indicates a high resolution value), reading at least one secondary buffer memory location corresponding to the pixel location 420 and then calculating an output color for the pixel location 430. Calculating the output color 430 if the look up table value does not indicate a high resolution marker comprises utilizing the data from the primary buffer memory location and does not include utilizing the data from at least one secondary buffer memory location to calculate the output color. Calculating the output color 430 in the case where the lookup value is a high resolution value comprises utilizing the data from at least one secondary buffer memory location, but not utilizing the data from the primary buffer memory location to calculate the output color 430, since the data from the primary buffer memory location merely corresponds to a high resolution value marker in this instance, for example a “11111111” in the case of an 8 bit lookup table, and is an indication to the display converter that high resolution color depth information exists on at least one secondary buffer memory location.

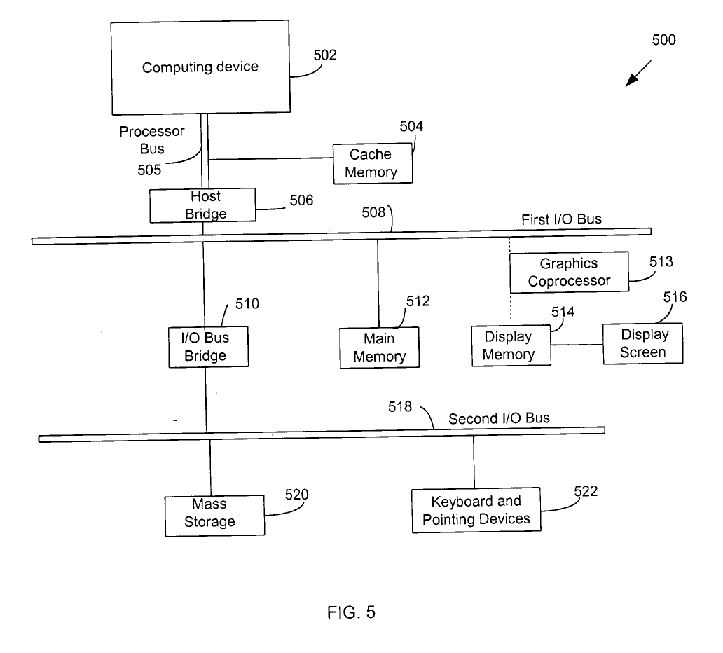

FIG. 5 is a diagram illustrating a sample system capable of being operated with a method for creating a variable depth display in accordance with the present invention. Sample system 500 may be used, for example, to execute the processing for the methods described herein. Sample system 500 includes computing device 502 and cache memory 504 coupled to each other through processor bus 505. Sample system 500 also includes first I/O bus 508 and second I/O bus 518. Processor bus 505 and first I/O bus 508 may be bridged by host bridge 506, whereas first I/O bus 508 and second I/O bus 518 may be bridged by I/O bus bridge 510. Coupled to first I/O bus 508 may be main memory 512 and display memory 514. The sample system 500 may also include a graphics coprocessor 513, however incorporation of the graphics coprocessor 513 into the sample system 500 is not necessary to the operation of the sample system 500. Coupled to display memory 514 may be display screen 516. Coupled to second I/O bus 518 may be mass storage 520, and keyboard and pointing devices 522.

These elements perform their conventional functions well known in the art. In particular, mass storage 520 may be used to provide long-term storage for the executable instructions for a method for providing variable depth displays in accordance with embodiments of the present invention, whereas main memory 512 may be used to store on a shorter term basis the executable instructions of a method for providing transparent displays in accordance with embodiments of the present invention during execution by computing device 502. In addition, the instructions may be stored on other machine readable mediums accessible by the system, such as compact disk read only memories (CD-ROMs), digital versatile disks (DVDs), and floppy disks, for example.

As described above, the method and apparatus for the creation of a variable depth display of the present invention provides an economical means by which to utilize memory associated with a graphic display system, thereby lowering the overall cost of such systems, which becomes increasingly important since display resolution requirements increase with every new generation of display systems. The method and apparatus of the present invention is particularly important to those applications in which memory usage is required to be kept at a minimum, such as in web tablets, personal digital assistants (PDA's) and cellular telephones.

Although the foregoing description has specified certain steps and materials that may be used in the method of the present invention, those skilled in the art will appreciate that many modifications and substitutions may be made. Accordingly, it is intended that all such modifications, alterations, substitutions and additions be considered to fall within the spirit and scope of the invention as defined by the appended claims. In addition, it is appreciated that the display system of the present invention is well known in the art. Therefore, it is appreciated that the Figures provided herein illustrate only portions of an exemplary display system that pertains to the practice of the present invention. Thus the present invention is not limited to the structures and components described herein.

What is claimed is:

1. A method of creating a variable depth display, comprising:
reading data from a primary buffer memory location corresponding to a pixel location on a display screen;
reading data from a marker buffer memory location corresponding to the pixel location, wherein a marker buffer value is obtained;
reading data from at least one secondary buffer memory location corresponding to the pixel location if the marker buffer value indicates a high resolution value; and
calculating an output color for the pixel location, wherein the output color is displayed in the pixel location on a display screen.

2. The method of claim 1, wherein calculating the output color comprises utilizing the data from the primary buffer memory location and does not utilize the data from the at least one secondary buffer memory location if the marker buffer value does not indicate a high resolution value.

3. The method of claim 1, wherein calculating the output color comprises utilizing the data from the primary buffer memory location and the data from the at least one secondary buffer memory location if the marker buffer value indicates a high resolution value.

4. The method of claim 1 further including sending the output color to the display screen by a display converter.

5. A method of creating a variable depth display, comprising:
reading data from a primary buffer memory location corresponding to a pixel location, wherein a look up table value for the primary buffer memory location data is obtained;
reading data from at least one secondary buffer memory location corresponding to the pixel location if the look up table value indicates a high resolution value;
calculating an output color for the pixel location, wherein the output color is displayed in the pixel location on a display screen.

6. The method of claim 5 wherein reading data from a primary buffer memory location comprises reading data from a palletized primary buffer in which the primary buffer memory location resides.

7. The method of claim 5, wherein calculating the output color comprises utilizing the data from the primary buffer memory location and does not include utilizing the data from the at least one secondary buffer memory location if the look up table value is not a high resolution marker.

8. The method of claim 5, wherein calculating the output color comprises utilizing the data from the at least one secondary buffer if the look up table value is a high resolution marker.

9. A system for creating a variable depth display, comprising:
a primary buffer memory location corresponding to a pixel location to receive data from a CPU;
at least one secondary buffer memory location corresponding to the pixel location to receive data from the CPU;
a marker buffer memory location corresponding to the pixel location to receive a marker buffer value from the CPU;
a display converter to calculate a color output for the pixel location, wherein the color output is calculated from only the primary buffer memory location if the marker buffer value indicates a high resolution value, or from the data received by both the primary buffer and the at least one secondary buffer memory location if the marker buffer value indicates a high resolution value; and
a CRT screen to display the color output calculated by the display converter.

10. The system of claim 9 wherein the display converter is a RAMDAC.

11. The system of claim 9 wherein the primary buffer is a frame buffer.

12. A system for creating a variable depth display, comprising:
a primary buffer memory location corresponding to a pixel location to receive data from a CPU;
at least one secondary buffer memory location corresponding to the pixel location to receive data from a CPU;
a display converter to calculate a color output for the pixel location, wherein the color output is calculated from only the primary buffer memory location if a lookup table value corresponding to the primary buffer memory location does not indicate a high resolution value, or from the data received by the at least one secondary buffer memory location if the lookup table value corresponding to the primary buffer memory location indicates a high resolution value; and
a CRT screen to display the color output from the display converter.

13. The system of claim 12 wherein the display converter is a RAMDAC.

14. The system of claim 12 wherein the primary buffer is a frame buffer.

15. An article comprising a machine readable medium having stored therein a plurality of machine readable instructions executable by a processor, the machine readable instructions comprising instructions to read data from a primary buffer memory location corresponding to a pixel location, to read data from a marker buffer memory location corresponding to the pixel location, to read data from at least one secondary buffer memory location corresponding to the pixel location if a high value marker is read from the marker buffer, and to calculate an output color for the pixel location wherein the output color is displayed in the pixel location on a display screen.

16. The article of claim 15, wherein instructions to calculate the output color further comprise utilizing the data from the primary buffer memory location and not utilizing the data from the at least one secondary buffer memory location if the marker buffer value does not indicate a high resolution value.

17. The article of claim 15, wherein instructions to calculate the output color further comprise utilizing the data from the primary buffer memory location and the data from the at least one secondary buffer memory location if the marker buffer value indicates a high resolution value.

18. An article comprising a machine readable medium having stored therein a plurality of machine readable instructions executable by a processor, the machine readable instructions comprising instructions to read data from a primary buffer memory location corresponding to a pixel location, wherein a look up table value for the primary buffer memory location data is obtained, to read data from at least one secondary buffer memory location corresponding to the pixel location if the lookup table value indicates a high resolution value, and to calculate an output color for the pixel location wherein the output color is displayed in the pixel location on a display screen.

19. The article of claim 18 wherein instructions to read data from a primary buffer memory location further comprise reading data from a palletized primary buffer in which the primary buffer memory location resides.

20. The article of claim 18, wherein instructions to calculate the output color further comprise utilizing the data from the primary buffer memory location and do not include utilizing the data from the at least one secondary buffer memory location if the look up table value does not indicate a high resolution marker.
